(19) United States
(12) Patent Application Publication
(10) Pub. No.: US 2012/0042725 A1
(43) Pub. Date: Feb. 23, 2012

(54) Method and Apparatus for Measuring Pedaling Dynamics of a Cyclist

(76) Inventors: Alan Francis Cote, Williston, VT (US); John Charles Croy, Middletown, RI (US); Jean Joseph Cote, Lunenburg, MA (US)

(21) Appl. No.: 13/216,215

(22) Filed: Aug. 23, 2011

Related U.S. Application Data
(60) Provisional application No. 61/376,021, filed on Aug. 23, 2010.

(51) Int. Cl. G01P 15/00

(52) U.S. Cl. 73/488; 73/865.4

(57) ABSTRACT

The invention detects variation in the speed of the bicycle's drive chain using a sensor. Variations in chain speed are measured, with the resulting numbers displayed to be visible to the cyclist in real-time and/or saved for later downloading and viewing via computer. Metrics that can be calculated using variations in chain speed include: a smoothness index, which indicates how evenly the cyclist is applying force/power; chain speed variation to show the contribution of each leg to the overall force/power delivered; pedaling cadence; and a calculation of gear ratios. Some of these metrics can use inputs from additional sensors, such as a cadence sensor that is tripped by each revolution of the bicycle's crank arm, and wheel speed or GPS sensor for measuring the bicycle's speed.

### CROSS-REFERENCE TO RELATED APPLICATION

This application claims the benefit of U.S. Provisional Application #61/376,021 filed Aug. 23, 2010

### BACKGROUND

1. Field of the Invention

The invention relates to a method and apparatus for measuring the pedaling dynamics of a cyclist. There are numerous metrics of interest to a cyclist, such as speed, pedaling cadence (RPM), power output, etc. In addition, cyclists have interest in the force they apply to the pedals not just in terms of absolute power in watts, but also in terms of the smoothness of the pedal stroke and the contribution of each leg to the total pedaling force/power. The force/power applied by human pedaling are unlike those created by a mechanical or electrical motor, where such motors apply force/power evenly through 360 degrees of rotation. Human pedaling force/power, however, varies greatly through a single rotation of a bicycle's cranks. Metrics that give additional information about the pedaling force/power applied by a cyclist are therefore of interest.

2. Description of Related Art

U.S. Pat. No. 6,199,021, and related C.I.P. 6,356,848 describe an apparatus and method for measuring the vibrational frequency of an elongate flexible member such as a bicycle chain. In such a system, a magnetic coil is used to measure the speed of the chain of the bicycle. The chain speed value is then used in the calculation of power, in combination with a second chain tension sensor.

A product in the market based on the above patents is the Polar Power Sensor Kit, manufactured by Polar Electro, Oy, Oulu Finland. This product includes the calculation of pedaling index (smoothness) and right/left pedaling balance, as subsets of power. These calculated pedaling index and right/left balance numbers require the use of both chain speed and chain tension sensors, and the resulting computationally-intensive calculation of power. Other systems for measuring the power output of cyclists are known both in patents and the marketplace. Related art can also be found in U.S. Pat. Nos. 6,356,848 and 6,199,021.

What's needed, therefore, is a system that produces pedaling smoothness and right/left balance numbers, but that requires fewer sensors and less computational power.

### BRIEF SUMMARY OF THE INVENTION

The invention detects variation in the speed of the bicycle's drive chain using a non-contact sensor. Variations in chain speed are measured, with the resulting numbers displayed to be visible to the cyclist in real-time and/or saved for later downloading and viewing via computer. In the preferred embodiment, a sensor is mounted to the bicycle's rear derailleur, with chain speed data transmitted to a handlebar-mounted computer/display. Metrics that can be calculated using variations in chain speed include a smoothness index, which indicates how evenly the cyclist is applying force /power through 360 degrees of the pedal stroke. In addition, chain speed variation can be used to show the contribution of each leg to the overall force/power delivered. This right/left balance can be calculated either with the single chain speed sensor, or in combination with a cadence sensor that is tripped by each revolution of the bicycle's crank arm. Additional sensors such as wheel speed or GPS can be used as additional inputs for calculating pedal metrics.

### BRIEF DESCRIPTION OF THE SEVERAL VIEWS OF THE DRAWINGS

FIG. 1 shows an overall view of a bicycle, including sensors as used in the present invention

FIG. 2 shows a chainspeed sensor mounted to the rear derailleur of a bicycle.

### DETAILED DESCRIPTION OF THE INVENTION

The invention broadly describes an apparatus and method for detecting variations in the chain speed of a bicycle. There are several different methods for measuring such chain speed variation. There are also several different metrics of interest that can be calculated using chain speed variation, as will be described. The invention is equally applicable to bicycle-like devices such as stationary bicycles, with the term bicycle intended herein and in the claims to include any such device with a chain and cogs.

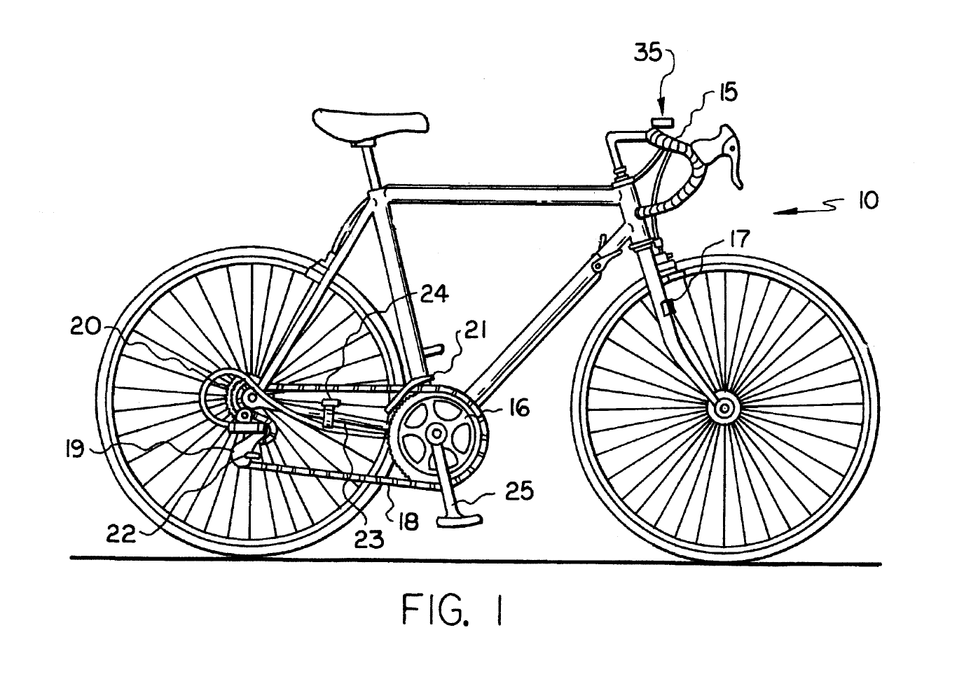

FIG. 1 shows an overall view of a bicycle 10, with chain speed sensor 22 mounted to the bicycle's rear derailleur 19. Chain 18 connects rear cogs 20 to the large front chainring 16. A bicycle includes an additional one or two smaller chainrings, which are obscured in FIG. 1 and therefore not shown. A front derailleur 21 shifts the chain to each of the different chainrings. Right crank 25 is shown, with the left crank obscured in this FIG. The derailleurs are controlled by cables and levers, which are outside the scope of the present invention and therefore not detailed for brevity.

FIG. 1 also shows computer 35, which mounts to handlebars 15. Such computers are readily know in the art, and may contain: a processor for the raw or already-processed signals from various sensors such as 22; a display so that the user can view the metrics numbers produced by the various sensors; and memory for storing the raw and/or calculated values for later examination by a user. Computer 35 may take the form of a dedicated device for bike applications, a more general use wristwatch, a cellphone, or other types of compact, mobile electronics. Also is FIG. 1 is optional cadence sensor 24, which mounts to right chainstay 23. Sensor 24 may be mounted in other suitable locations on the bicycle frame as well, such as the left chainstay (obscured). Wheel speed sensor 17 is also shown. Sensors 17 and 24 are typically reed switch types, which detect the passing of a magnet. A magnet is mounted to the bicycle crank and the bicycle wheel for each respective sensor.

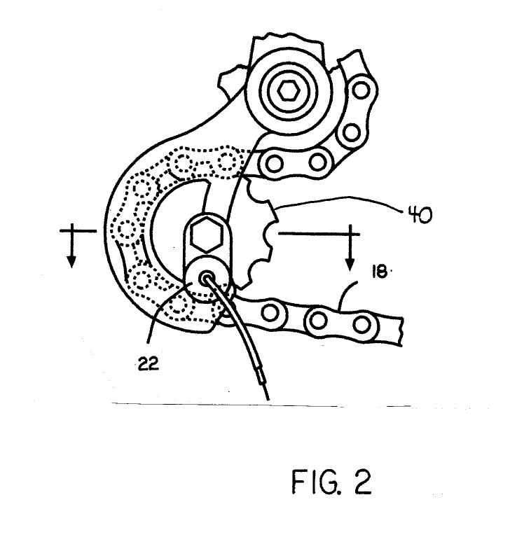

FIG. 2 shows a closer view of chain speed sensor 22 mounted to the rear derailleur 19, including chain 18. In this view, the bottom edge of chain speed sensor 22 is shown to terminate part way between the upper and lower edges of chain 18. In the preferred embodiment, the sensor is likely to extend all the way to the lower edge of chain 18, to be best positioned to detect the non-uniform density of the chain, as will be explained further. Pulley wheel 40 is shown, which has teeth that mate to the links of chain 18.

A magnetic coil, also known as a variable reluctance sensor, is the preferred type for sensor 22, but other sensors including but not limited to Hall Effect, magneto resistive sensors, inductive, capacitive, optical and acoustic sensors may also be used. Any of these sensor types are capable of sensing movement corresponding to the links of a chain. The data from the sensor is then transmitted to a computer. The sensor 22 produces a voltage signal as the ferrous chain 18 passes it. This signal shows the passing of each chain link, as the chain is of non-uniform density due to its link and pin structure. The time required for each link to pass can then be readily calculated, and therefore the link speed as well.

Metrics that can be calculated using variations in chain speed include a smoothness index, which indicates how evenly the cyclist is applying force /power through 360 degrees of the pedal stroke. For instance, if the cyclist is applying a smoother, more even force/power to the pedals, there will be less variation in chain speed than if the cyclist is applying a jerky, uneven force/power to the pedals. A smoothness index can be related to the rider in a number of ways, such as an index number (e.g. 10 for smoothest, down to 1 for choppiest), a graphical display, or an audible alarm.

In addition, chain speed variation can be used to show the contribution of each leg to the overall force/power delivered, called a right to left pedaling balance. If one leg is contributing more force/power than the other leg, there will be a variation in the chain speed that is apparent. This right to left pedaling balance can be calculated either with the single chain speed sensor, or preferably in combination with a cadence sensor that is tripped by each revolution of the bicycle's crank arm. The cadence sensor allows the chain speed variation to be correlated to the right or the left leg, as the cadence sensor can relate the position of one crank

Other metrics may be calculated from chain speed data as well. One metric is pedaling cadence, expressed as the RPM of a crank such as 25.

Another metric that can be calculated from chain speed data is the gear ratio that the bicycle is in. This is done in conjunction with inputs from other sensors including a cadence sensor 24, and/or a wheel speed sensor. Gear ratio is preferably expressed by the number of teeth in the front chainring and the number of teeth cogs, e.g. 52×13.

In addition, both the smoothness index and the right/left balance calculations can include a factor for pedaling cadence. That is, when cadence is lower, pedaling smoothness naturally tends to be lower than at higher cadence. For instance, a smoothness index score of 10 may allow for more chain speed variation at a cadence of 50 than at a cadence of 90.

In addition, both the smoothness index and the right/left balance calculations can include a factor for the speed of the overall bicycle. This allows kinetic energy, and/or momentum, to be included in smoothness and right/left balance calculations.

The metrics such as right/left balance and smoothness are created by processing the raw signal from sensor 22, with the processor either located at the sensor, or the raw chain speed signal transmitted to computer 35 and processed there, preferably located on the handlebars, though other locations may be used. The data may be displayed in real-time, and optionally stored for later downloading or analysis.

Examples of algorithms for computing the various metric discussed are included at the end of the Detailed Description. While these algorithms are examples of how to process each type of signal, different algorithms may also be used, as is understood by those skilled in the art. For instance, calculation of a smoothness index includes using a speed number from a wheel speed sensor, but this step could be omitted or changed to an input from different sensor.

The algorithms can be implemented on a processor, preferably as part of computer 35. Those skilled in the art are familiar with the standard programming practices and related hardware requirements required to implement these algorithms.

While mounting a sensor on the bicycle's rear derailleur is the most convenient location for an add-on sensor to monitor chainspeed, other locations are also possible. The chain speed sensor could be mounted to the frame of the bicycle, such as on the chainstay; to the front derailleur; or other locations.

Of course, the drive chain of the bicycle meshes and moves in synchronization not just with the rear derailleur pulleys, but also with the rear cogs and the front chainrings. Therefore, variations in the speed of the rear cogs or front chainrings can also be monitored, with the speed variation calculated in the same manner as that of a drive chain. Sensors can be employed to monitor the pass of each tooth of a rear cog or a front chainring, with sensor types similar to those used for chains.

There are still other methods usable to detect speed, and variations in speed, of the pedal stroke of a cyclist. Existing cyclometers often measure pedaling cadence by use of a magnet mounted to one crank, which trips a bicycle frame mounted reed switch with each complete, 360 degree rotation of one crank. However, a one-per-revolution (1/rev) measurement obviously does not have enough resolution to detect force, power, or speed variations within a single pedal stroke. Therefore, methods of measuring the angular velocity of one or both cranks with finer resolution than 1/rev. can also be employed as part of the invention. One method is to mount a ring containing a plurality of magnets, or a single magnet containing multiple poles, to one or both cranks, or to one of the front chainrings, such that a normal reed switch is tripped multiple times per crank revolution. Still another method uses an accelerometer attached to or built-into one or both cranks; or to one of the front chainrings; or to one or more of the rear cogs; or to one or more of the rear derailleur pulleys. Angular velocity of the cranks, chainring, cog, or pulley can then be calculated from the accelerometer, which may measure along multiple axes. An alternative embodiment monitors variation in the wheel speed of the bicycle, using a sensor configuration that detects the movement of the wheel more than once per revolution.

### Examples of Algorithms

Virtual Cadence

a) Using a timer running a sufficiently high frequency (e.g. 10 kHz or higher), record the signal from the chainspeed sensor.

b) Optionally, process the signal from part a with a low-pass filter that has a cutoff frequency above the highest practical frequency of interest, e.g. for a cadence of 180 rpm with a 52-tooth chainring, the signal has a frequency of 156 Hz. Double that value to prevent aliasing, and use a filter with a cutoff of 312 Hz.

c) Process the signal from part b with a time to frequency transform, such as a Fourier transform, Fast Fourier transform, zero-crossing detection with hysteresis, etc. In practice, the signal from a chainspeed sensor is likely to have a high enough S/N ratio that it will be adequate to measure the time between successive zero-crossings. The result is the time for each link to pass the sensor.

d) Optionally, use interpolation to further increase the accuracy of the zero-crossing times.

e) Process the signal from part c/d with a low-pass filter that has a cutoff frequency above the highest practical frequency of interest, e.g. for a cadence of 180 rpm, with one power stroke for each leg, the signal has a frequency of 360 rpm, or 6 Hz. Double that value to prevent aliasing, and use a filter with a cutoff of 12 Hz.

f) Process the signal from part e with a time to frequency transform, such as a Fourier transform, Fast Fourier transform, zero-crossing detection with hysteresis, etc. The primary frequency resulting will be at twice the cadence (for a rider with two legs). For a one-legged rider, the result will be at the cadence frequency, and other results may be produced by different configurations, e.g. for a tandem bicycle with the cranks 90 degrees out of phase, the frequency will be at four times cadence.

Smoothness

a) Using a timer running a sufficiently high frequency (e.g. 10 kHz or higher), record the signal from the chainspeed sensor.

b) Based on the cadence calculated from either a crank sensor or the virtual cadence calculation, take the samples from the part a signal corresponding to one crank revolution.

c) Using the methods described in parts b/c of Virtual Cadence, calculate the time for each link to pass the sensor.

d) Using the number of links as determined from part c, and the time for a crank revolution from part b, calculate the average time for a link to pass the sensor.

e) For each link time determined in part b, calculate the absolute value of the difference between the specific link speed and the average link speed.

f) Calculate the average of the differences from part e, and divide by the average link speed.

g) Determine the speed of the bicycle, using a wheel sensor, GPS, or other means.

h) Multiply the average from part f by the square of the speed from part g

i) Multiply the product from part h by the combined mass of the bicycle and rider. This result will be proportional to the variation in power of the rider, measured in watts.

Right/Left balance

a) Using a timer running a sufficiently high frequency (e.g. 10 kHz or higher), record the signal from the chainspeed sensor.

b) Based on the cadence calculated from either a crank sensor, take the samples from the part a signal corresponding to two one revolution of the crank The revolutions may start exactly when the crank sensor is detected, or they may start at a particular fraction of the time for one revolution. For example, if the crank sensor is set to indicate when the cranks are horizontal, and it is preferable to measure the right and left legs from a point where the cranks are vertical, then the samples may be offset by ¼ of the time for one pedal revolution, so if a revolution has 10000 samples, then the revolution would be from sample 2500 to 12499.

c) Optionally, determine the sample at which to start the first revolution by finding the link speed that is lowest.

d) Using the method described in part b of Smoothness, calculate the number of links to pass the sensor in each half-revolution.

e) Using the number of links from part d, separate the samples into a first half and a second half.

f) Separately calculate the variation in power for the first half and the second half, using the method from parts e/f/g/h/i of Smoothness.

g) Use the ratio of the two values from part f as the Right/Left balance. Which half corresponds to each leg is determined by the position of the crank sensor.

Gear Indicator

a) Using the methods described in the sections above, determine the average chain speed.

b) Using the chain pitch (links/inch), convert the value from part a to links/sec.

c) Using a wheel sensor, measure the rotational speed of the wheel in wheelrevs/sec.

d) Divide links/sec by wheelrevs/sec to determine the number of teeth on the rear cog.

e) Using a crank sensor or the Virtual Cadence method, measure the rotational speed of the crank in crankrevs/sec

f) Divide links/sec by crankrevs/sec to determine the number of teeth on the front chainring.

g) Optionally, calculate (wheel diameter)(chainring teeth)/(cog teeth) to determine “gear inches”.

Alternate method: depending on the characteristics of the chainspeed sensor, it may be possible to generate a simple interrupt signal when each link passes. In that case, rather than collecting a series of analog-to-digital values at the sampling rate, it will be sufficient to record the time directly at each interrupt. This will eliminate the need for the initial processing, e.g. for Virtual Cadence, these values can be used to start from part e.

Although the present invention has been described with respect to one or more embodiments, it will be understood that other embodiments of the present invention may be made without departing from the spirit and scope of the present invention. Hence, the present invention is deemed limited only by the appended claims and the reasonable interpretation thereof.

What is claimed:

1. A method for detecting variations in speed of a bicycle chain, comprising: sensing movement corresponding to links of said chain, and transmitting said sensing movement data to a computer.

2. The method of claim 1, where movement is sensed by said links moving past a sensor mounted to a rear derailleur of a bicycle.

3. The method of claim 1, where movement is sensed by an accelerometer housed in a pulley wheel of said rear derailleur.

4. The method of claim 1, where movement is sensed by an accelerometer housed in a crankset of a bicycle.

5. The method of claim 1, where movement is sensed by at least one magnet housed in a crankset of said bicycle, and at least one sensor mounted to a bicycle.

6. The method of claim 1, where movement is sensed by at least one sensor housed in a crankset of said bicycle, and at least one sensor mounted to a bicycle.

7. The method of claim 1, further comprising using a cadence sensor to measure pedaling cadence, using a sensor to measure bicycle speed, and combining outputs of said cadence sensor and said movement sensor and said bicycle speed sensor to calculate gear ratios of a bicycle.

8. An apparatus for detecting variations in right to left pedaling balance of a cyclist, comprising: a sensor which detects movement of chain links, said sensor mounted in proximity to a chain; and a computer for receiving a resulting signal from said sensor.

9. The apparatus of claim 8, in which said sensor is mounted a bicycle's rear derailleur.

10. The apparatus of claim 8, further comprising a crank cadence sensor, whose signal is transmitted to said computer.

11. The apparatus of claim 10, where said computer displays a value corresponding to said right to left pedaling balance.

12. An apparatus for calculating a pedaling smoothness index of a cyclist, comprising: a sensor which detects movement of chain links, said sensor mounted in proximity to a chain; and a computer for receiving a resulting signal from said sensor.

13. The apparatus of claim 12, in which said sensor is mounted a bicycle's rear derailleur.

14. The apparatus of claim 12, further comprising using bicycle speed as an additional factor in calculating said pedaling smoothness index.

15. The apparatus of claim 14, where bicycle speed is determined by a sensor that measures rotations of a bicycle wheel.

16. The apparatus of claim 14, where bicycle speed is determined from a global positioning system sensor.

17. The apparatus of claim 12, where said computer displays a value corresponding to said pedaling smoothness index.

18. An apparatus for measuring pedaling cadence of a cyclist, comprising: a sensor which detects movement of chain links, said sensor mounted in proximity to a chain; and a computer for receiving a resulting signal from said sensor.

19. The apparatus of claim 18, in which said sensor is mounted a bicycle's rear derailleur.

20. The apparatus of claim 18, where said computer displays a value corresponding to said pedaling cadence.
